(19) United States
(12) Patent Application Publication
(10) Pub. No.: US 2020/0102765 A1
(43) Pub. Date: Apr. 2, 2020

(54) ATTACHMENT FOR A POOL VACUUM

(71) Applicant: TECHTRONIC CORDLESS GP, Anderson, SC (US)

(72) Inventors: Scott P. Kippes, Piedmont, SC (US); Douglas K. Ritterling, Anderson, SC (US)

(21) Appl. No.: 16/584,099

(22) Filed: Sep. 26, 2019

Related U.S. Application Data
(60) Provisional application No. 62/739,667, filed on Oct. 1, 2018.

(51) Int. Cl. E04H 4/16; B08B 1/00; A46B 15/00

(52) U.S. Cl. CPC E04H 4/1636; A46B 2200/3073; A46B 15/00; B08B 1/002

(57) ABSTRACT

An attachment for a pool vacuum includes a housing and a brushroll at least partially extending from the housing. The brushroll has a plurality of bristles configured to rotate about a first axis. The attachment further comprises a paddle wheel disposed in the housing. The paddle wheel is configured to rotate about a second axis that is parallel to the first axis. The attachment further comprises a torque transmission member coupling the brushroll and the paddle wheel. In response to rotation of the paddle wheel about the second axis, the torque transmission member is configured to rotate the brushroll about the first axis.

### CROSS-REFERENCE TO RELATED APPLICATIONS

This application claims priority to co-pending U.S. Provisional Patent Application No. 62/739,667, filed on Oct. 1, 2018, the entire content of which is incorporated herein by reference.

### FIELD OF THE DISCLOSURE

The present disclosure relates to pool vacuums, and more particularly to attachments for pool vacuums.

### BACKGROUND OF THE DISCLOSURE

Pool vacuums have a body that impels water into the body to facilitate cleaning of a pool. Different attachments may be coupled to the body of the pool vacuum to facilitate different cleaning functions.

### SUMMARY OF THE DISCLOSURE

The present disclosure provides, in one aspect, an attachment for a pool vacuum. The attachment comprises a housing and a brushroll at least partially extending from the housing. The brushroll has a plurality of bristles configured to rotate about a first axis. The attachment further comprises a paddle wheel disposed in the housing. The paddle wheel is configured to rotate about a second axis that is parallel to the first axis. The attachment further comprises a torque transmission member coupling the brushroll and the paddle wheel. In response to rotation of the paddle wheel about the second axis, the torque transmission member is configured to rotate the brushroll about the first axis.

The present disclosure provides, in another aspect, a pool vacuum comprising a main housing and a motor disposed in the main housing. The motor drives an impeller. The pool vacuum further comprises a filter coupled to the main housing for providing an inlet for a water current to enter into the main housing. The pool vacuum further comprises an attachment coupled to the main housing. The attachment includes an attachment housing and a brushroll at least partially extending from the attachment housing. The brushroll has a plurality of bristles and configured to rotate about a first axis. The attachment also includes a paddle wheel positioned downstream from the brushroll. The paddle wheel is configured to rotate about a second axis that is parallel to the first axis. The attachment also includes a torque transmission member coupling the brushroll to the paddle wheel. In response to the motor driving the impeller, the water current is configured to be drawn through the paddle wheel, such that the paddle wheel is caused to rotate about the second axis. In response to rotation of the paddle wheel about the second axis, the coupling member is configured to rotate the brushroll about the first axis.

The present disclosure provides, in yet another aspect, an attachment for a pool vacuum. The attachment comprises a housing including a first portion and a second portion that is fluidly coupled to the first potion by a passage. The second portion includes an opening. The attachment further comprises a brushroll disposed adjacent to the second portion and configured to rotate about a first axis. The brushroll includes a plurality of bristles that extend through the opening. The attachment further comprises a paddle wheel arranged in the first portion of the housing and configured to rotate about a second axis that is parallel to the first axis. The attachment further comprises a lip at least partially defining a nozzle through which the passage extends. The nozzle is configured to direct a current of water toward the paddle wheel. The attachment further comprises a paddle pulley coupled for co-rotation with the paddle wheel. The attachment further comprises a brushroll pulley coupled for co-rotation with the brushroll. The attachment further comprises a belt arranged about the paddle pulley and the brushroll pulley. In response to rotation of the paddle wheel about the second axis, the belt is configured to rotate the brushroll about the first axis.

Other features and aspects of the disclosure will become apparent by consideration of the following detailed description and accompanying drawings.

### BRIEF DESCRIPTION OF THE DRAWINGS

FIG. 1 is a perspective view of a pool vacuum with an attachment.

FIG. 2 is a plan view of the pool vacuum and attachment of FIG. 1.

FIG. 3 is a perspective view of the attachment of FIG. 1, with portions removed.

FIG. 4 is a cross-sectional view of the attachment of FIG. 1.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

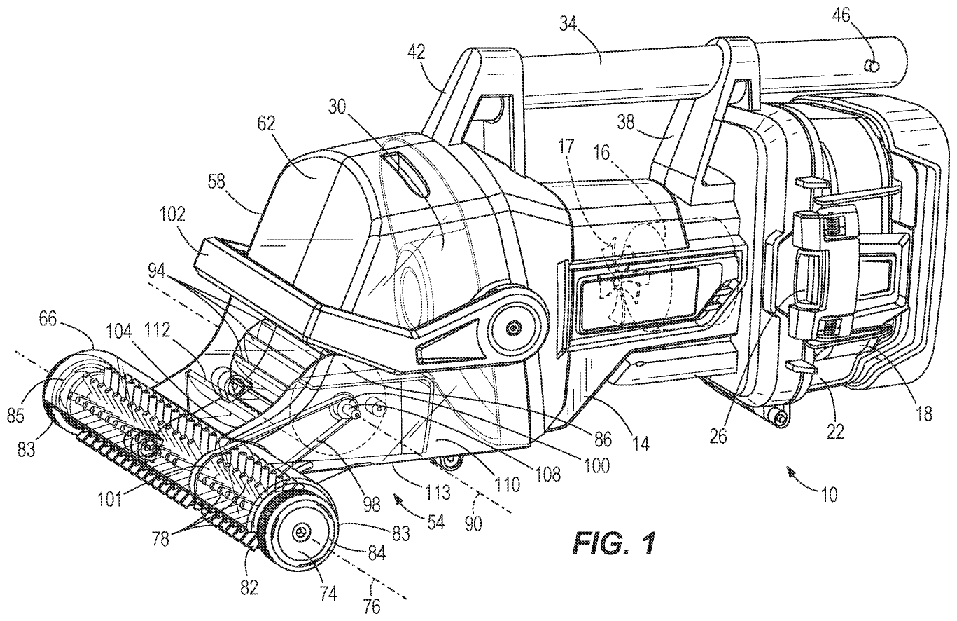

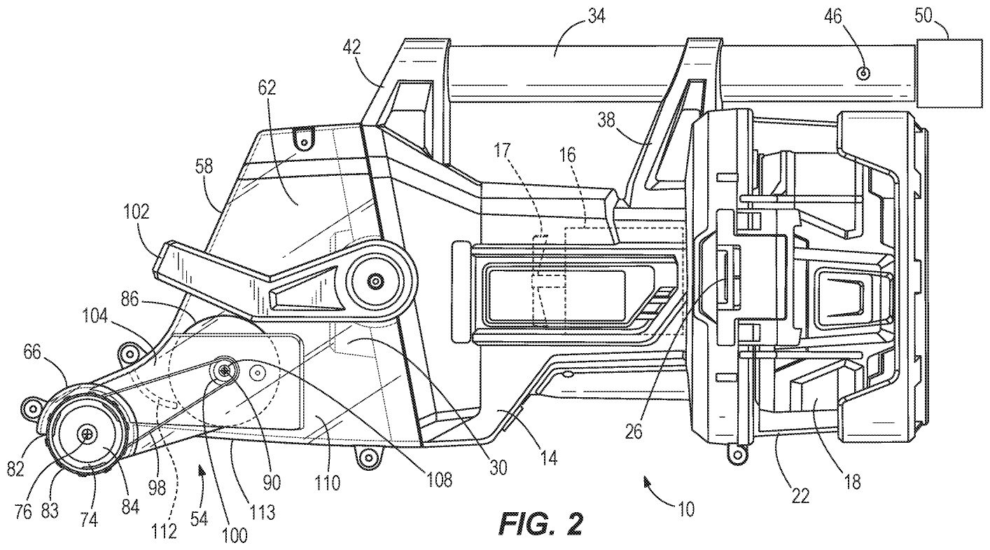

As shown in FIGS. 1 and 2, a hand-held pool vacuum 10 has a main housing 14, a motor 16 enclosed in the housing 14, and an impeller 17 driven by the motor in the main housing 14. A removable battery pack 18 provides power to the motor and is sealed to the main housing 14 by way of a hinged battery cover 22 with latches 26, permitting the battery pool vacuum 10 to be submerged in water. Although latches 26 are shown and described herein, other connection and/or sealing mechanisms are contemplated (e.g., a waterproof seal may be positioned on or around the cover 22, a sealing ring may be positioned on or around the cover 22, a spring loaded push-button mechanism may be used to attach the cover 22 to the housing 14, and/or the like).

A filter 30 may be coupled to the main housing 14, which provides an entrance for water, or other liquid, to enter into the main housing 14. The pool vacuum 10 may include a removable short pole 34, e.g., configured as a handle, that is insertable through a first support 38 and removably attachable to a second support 42 on the main housing 14. The removable short pole 34 may include a first detent that retains the short pole 34 on the second support 42. The short pole 34 may additionally include a second detent 46 for selectively retaining a removable long pole 50 (a portion of which is shown FIG. 2) to the removable short pole 34. In this way, an operator may use the removable short pole 34 to manipulate the pool vacuum 10 or may use the removable long pole 50 to manipulate the pool vacuum 10 from a distance, for instance, when running the pool vacuum 10 along the bottom of a deep end of a pool.

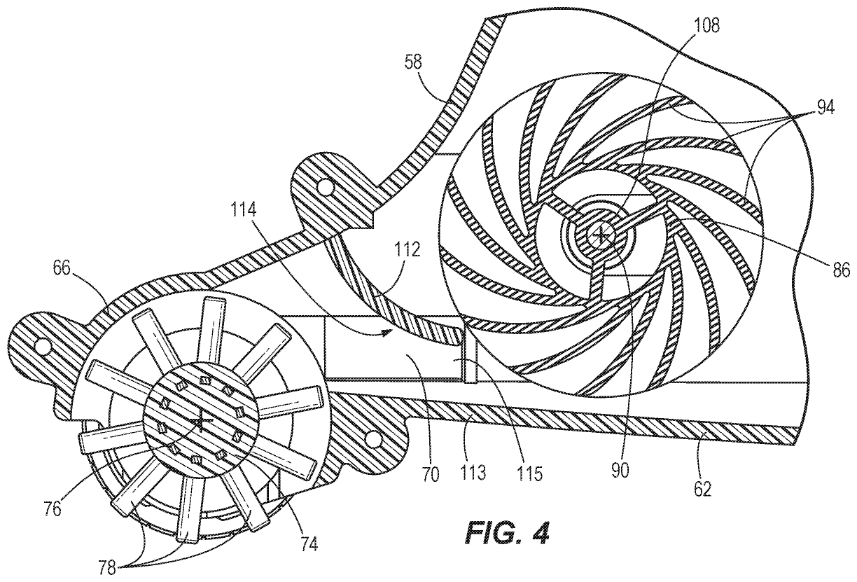

The pool vacuum 10 may include and/or be usable with a removable cleaning attachment 54. The attachment 54 may include an attachment housing 58 having a container portion 62 (e.g., also referred to as a first portion) in which debris from the pool is collected and a semi or partial-cylindrical portion 66 (e.g., also referred to as a second portion). A passage 70 (FIG. 4) may fluidly couple the partial-cylindrical portion 66 to the container portion 62. In the embodiment illustrated in FIGS. 1 and 2, the attachment housing 58 is transparent (e.g., or at least semi-transparent) to allow an operator to see into the main housing 14. In other embodiments, the attachment housing 58 may be opaque or semi-opaque. The attachment 54 may additionally include a brushroll 74 that is rotatable around or about a first axis 76 in the partial-cylindrical portion 66. The brushroll 74 may include a plurality of bristles 78 that are configured to contact a surface of the pool through an opening 82 in the partial-cylindrical portion 66. The brushroll 74 may additionally include a pair of end caps 83 disposed on opposite first and second ends 84, 85 of the brushroll 74. The caps 83 are arranged outside the partial-cylindrical portion 66, such that they can easily be manually manipulated by a user to rotate the brushroll 74 about the first axis 76 while the pool vacuum 10 is not running. In this way, a user may more easily remove debris that is wrapped around and/or entangled with the brushroll 74. The attachment 54 may additionally include a rotating drive member, e.g. a paddle wheel 86 in the illustrated embodiment, that is rotatable around or about a second axis 90 in the container portion 62 proximate the passage 70. The second axis 90 may be parallel to the first axis 76, in some embodiments.

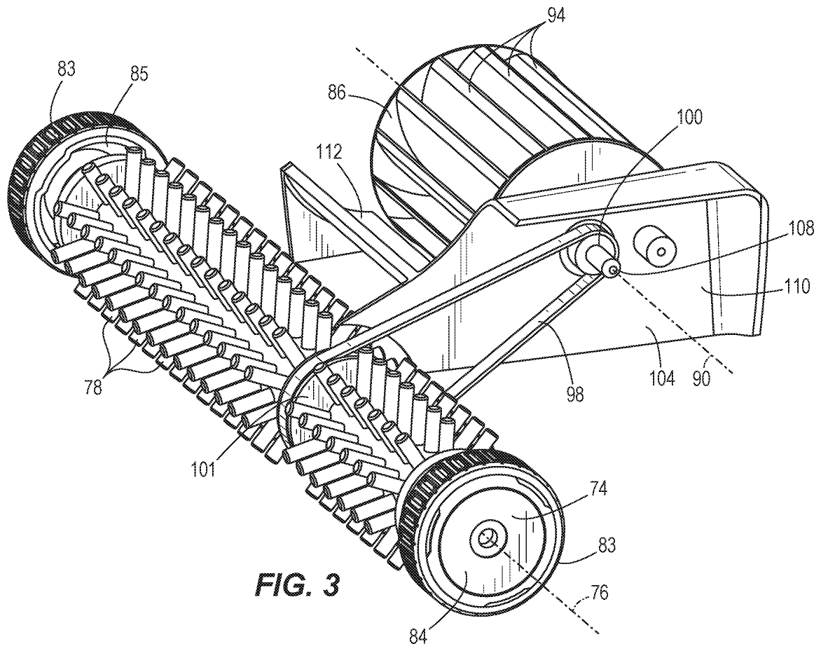

The paddle wheel 86 has a plurality of paddles 94 over which a water current (e.g. induced through the partial-cylindrical portion 66 and the passage 70) flows. A torque transmission member, e.g. a belt 98 in the illustrated embodiment, may be arranged around a paddle pulley 100 and coupled thereto for co-rotation with the paddle wheel 86 and a brushroll pulley 101 coupled for co-rotation with the brushroll 74 (FIG. 3), such that the brushroll 74 rotates in response to rotation of the paddle wheel 86 via the belt 98. The attachment 54 may be removably attachable to the main housing 14 of the pool vacuum 10 in a position in which the filter 30 of the pool vacuum 10 is received in the container portion 62. In the illustrated embodiment, the container portion 62 of the attachment 54 is coupled to the main housing 14 of the pool vacuum 10 via a friction fit, but in other embodiments, a detent arrangement, fasteners, latches, hinges, or a push button may be used to couple the container portion 62 of the attachment 54 to the main housing 14 of the pool vacuum 10. In some embodiments, the attachment 54 is not removably coupled to the pool vacuum 10, but instead is integrally formed as part of the pool vacuum 10. A handle 102 may be pivotably coupled to the container portion 62 of the attachment 54, such that when the attachment 54 is removed from the pool vacuum 10, the handle 102 may be used to conveniently transport the attachment 54.

FIG. 3 illustrates the attachment 54 with the attachment housing 58 removed to show a bracket 104 arranged within and coupled to attachment housing 58. In some embodiments, the bracket 104 is integrally formed with the attachment housing 58. A rotation shaft 108 of the paddle wheel 86, that defines the second axis 90, extends through the bracket 104, and the paddle pulley 100 may be arranged on the rotation shaft 108. As shown in FIGS. 1 and 2, chamber 110 is defined between the bracket 104 and the container portion 62. The chamber 110 is separated from the passage 70 by the bracket 104. The belt 98 and the paddle pulley 100 are arranged in the chamber 110.

A curvilinear lip 112 may extend from a side of the bracket 104 opposite the chamber 110. The lip 112 and a bottom side 113 of the container portion 62 define a nozzle 114 through which the passage 70 extends. An outlet 115 of the nozzle 114 at the termination of the passage 70 is arranged below the second axis 90, such that the water current discharged from the nozzle 114 impinges upon the paddles 94 located below the second axis 90. Because the outlet 115 is in facing relationship with paddles 94 below the second axis 90, the water current imparts a counter-clockwise torque on the paddle wheel 86 and the rotation shaft 108, as viewed in FIG. 4, thereby also causing a counterclockwise rotation of the brushroll 74. In the flow path of the water current, the paddle wheel 86 is downstream of the brushroll 74.

In operation, the attachment 54 is secured on the pool vacuum 10 and the pool vacuum 10 is placed in a pool with water such that the bristles 78 extending through opening 82 of the partial-cylindrical portion 66 are engaged against a pool surface. The motor then rotates the impeller in the main housing 14, inducing a water current through the opening 82 of the partial-cylindrical portion 66 of the attachment housing 58 of the attachment 54. Water passes from the partial-cylindrical portion 66 and through the passage 70 into the container portion 62 of the attachment housing 58. The water current thus flows over and/or around the paddles 94 of the paddle wheel 86, causing the paddle wheel 86 to rotate around or about the second axis 90. As the paddle wheel 86 rotates, so does the belt 98, thus causing the brushroll 74 to rotate about the first axis 76, thereby causing the bristles 78 to scrape against and clean the pool surface. After passing over and/or around the paddle wheel 86, the water is drawn through the filter 30 and into the main housing 14 of the pool vacuum 10 by the impeller, after which the filtered water is exhausted from the main housing 14. Thus, the attachment 54 provides a rotating, cleaning brushroll 74 powered by the water current drawn into the pool vacuum 10.

Various features of the disclosure are set forth in the following claims.

What is claimed is:

1. An attachment for a pool vacuum, the attachment comprising:
a housing;
a brushroll at least partially extending from the housing, the brushroll having a plurality of bristles configured to rotate about a first axis;
a paddle wheel disposed in the housing, the paddle wheel being configured to rotate about a second axis that is parallel to the first axis; and
a torque transmission member coupling the brushroll and the paddle wheel,
wherein, in response to rotation of the paddle wheel about the second axis, the torque transmission member is configured to rotate the brushroll about the first axis.

2. The attachment of claim 1, further comprising a pivotal handle coupled to the housing.

3. The attachment of claim 1, wherein the housing includes a first portion in which the paddle wheel is arranged and a second portion that is coupled to the first portion, and wherein the brushroll is arranged in the second portion.

4. The attachment of claim 3, wherein the second portion comprises a partial-cylindrical portion that includes an opening through which the plurality of bristles extends.

5. The attachment of claim 3, wherein the brushroll includes a first endcap arranged outside the second portion.

6. The attachment of claim 5, wherein the brushroll includes a second endcap opposite the first endcap, and wherein the second endcap is arranged outside the second portion.

7. The attachment of claim 3, further comprising a passage fluidly coupling the first portion and the second portion.

8. The attachment of claim 7, wherein the passage extends through a nozzle that is defined at least partially by a curvilinear lip and the first portion, the nozzle being configured to direct a water current toward the paddle wheel.

9. The attachment of claim 7, further comprising a bracket coupled to the housing, wherein the paddle wheel includes a rotation shaft extending through the bracket that defines the second axis.

10. The attachment of claim 9, further comprising a paddle pulley coupled for co-rotation with the rotation shaft and a brushroll pulley coupled for co-rotation with the brushroll, wherein the torque transmission member is a belt arranged around the paddle pulley and the brushroll pulley.

11. The attachment of claim 10, wherein a chamber is defined between the bracket and the housing, and wherein the paddle pulley and the belt are arranged in the chamber.

12. The attachment of claim 11, wherein the chamber is separated from the passage by the bracket.

13. The attachment of claim 12, wherein the bracket includes a curvilinear lip extending from a side of the bracket opposite the chamber, and wherein the curvilinear lip at least partially defines a nozzle through which the passage extends.

14. The attachment of claim 13, wherein the nozzle is configured to direct a water current toward the paddle wheel.

15. The attachment of claim 1, further comprising a paddle pulley coupled for co-rotation with the paddle and brushroll pulley coupled for co-rotation with the brushroll, wherein the torque transmission member is a belt is arranged around the paddle pulley and the brushroll pulley.

16. A pool vacuum comprising:
a main housing;
a motor disposed in the main housing, the motor driving an impeller;
a filter coupled to the main housing for providing an inlet for a water current to enter into the main housing; and
an attachment coupled to the main housing, the attachment including:
an attachment housing;
a brushroll at least partially extending from the attachment housing, the brushroll having a plurality of bristles and configured to rotate about a first axis;
a paddle wheel positioned downstream from the brushroll, the paddle wheel being configured to rotate about a second axis that is parallel to the first axis; and
a torque transmission member coupling the brushroll to the paddle wheel,
wherein, in response to the motor driving the impeller, the water current is configured to be drawn through the paddle wheel, such that the paddle wheel is caused to rotate about the second axis, and
wherein in response to rotation of the paddle wheel about the second axis, the coupling member is configured to rotate the brushroll about the first axis.

17. The pool vacuum of claim 16, wherein the attachment housing is transparent.

18. The pool vacuum of claim 16, wherein the attachment housing is removably coupled to the main housing.

19. The pool vacuum of claim 18, wherein the attachment housing is removably coupled to the main housing via a friction fit.

20. An attachment for a pool vacuum, the attachment comprising:
a housing including a first portion and a second portion that is fluidly coupled to the first potion by a passage, the second portion including an opening;
a brushroll disposed adjacent the second portion and configured to rotate about a first axis, the brushroll including a plurality of bristles that extend through the opening;
a paddle wheel arranged in the first portion of the housing and configured to rotate about a second axis that is parallel to the first axis;
a lip at least partially defining a nozzle through which the passage extends, the nozzle being configured to direct a current of water toward the paddle wheel;
a paddle pulley coupled for co-rotation with the paddle wheel;
a brushroll pulley coupled for co-rotation with the brushroll; and
a belt arranged about the paddle pulley and the brushroll pulley,
wherein, in response to rotation of the paddle wheel about the second axis, the belt is configured to rotate the brushroll about the first axis.
